(19) United States
(12) Patent Application Publication
(10) Pub. No.: US 2019/0342382 A1
(43) Pub. Date: Nov. 7, 2019

(54) METHOD AND ELECTRONIC DEVICE FOR SUPPORTING ARTIFICIAL PARTICIPATION IN DECISION-MAKING OF BLOCKCHAIN

(71) Applicant: ZhongAn Information Technology Service Co., Ltd., Shenzhen (CN)

(72) Inventors: Zhengchao TANG, Shenzhen (CN); Jingqi CAO, Shenzhen (CN)

(21) Appl. No.: 16/516,752

(22) Filed: Jul. 19, 2019

Related U.S. Application Data
(63) Continuation of application No. PCT/CN2018/100839, filed on Aug. 16, 2018.

(30) Foreign Application Priority Data
Oct. 11, 2017 (CN) 201710941501.3

(51) Int. Cl. H04L 29/08; H04L 29/06; H04L 9/06; G06F 16/182

(52) U.S. Cl. CPC H04L 67/1044; G06F 16/1837; H04L 9/0637; H04L 67/40

(57) ABSTRACT

A method and an electronic device for supporting artificial participation in decision-making of blockchain, by receiving feedback information inputted by the user in the node and broadcasting the feedback information to other nodes for performing decision-making processing, enable a user to initiate and participate in voting through a node of the blockchain, and avoid restrictions on decision-making initiation and participation, while avoiding dependence on the network and improving stability.

### CROSS-REFERENCE TO RELATED APPLICATIONS

The present application is a continuation of International Application No. PCT/CN2018/100839, filed on Aug. 16, 2018, which claims priority to Chinese patent application No. 201710941501.3, filed on Oct. 11, 2017. Both applications are incorporated herein in their entireties by reference.

### TECHNICAL FIELD

Embodiments of the present application relate to the field of computers, and in particular to a method and an electronic device for supporting artificial participation in decision-making of blockchain.

### BACKGROUND

In the existing blockchain technology, there often exist scenes that require artificial participation in decision-making of blockchain. A technical solution provided by the existing technology is that a server sends a request to a plurality of linked decision-making devices, and a user implements the artificial participation in a voting decision-making through the plurality of decision-making devices. In a process of using the existing technology, if there are situations such as the server is attacked etc., accuracy of a decision-making result will be affected; dependence on the network is strong; and stability and security are poor.

Therefore, it is urgent to provide a method for supporting artificial participation in decision-making of blockchain.

### SUMMARY

In order to solve the problems in the prior art, embodiments of the present application provide a method and an electronic device for supporting artificial participation in decision-making of blockchain. The technical solution is as follows.

According to an aspect of the embodiments of the present application, a method for supporting artificial participation in decision-making of blockchain is provided, which includes: receiving, by a second node of a plurality of nodes in the blockchain, a decision-making request that is broadcasted by a first node of the plurality of nodes to at least two second nodes of the plurality of nodes; receiving, by the second node, feedback information for the decision-making request inputted by a user corresponding to the second node; and broadcasting, by the second node, the feedback information to at least two third nodes of the plurality of nodes except the second node after the user corresponding to the second node inputs the feedback information, so that the at least two third nodes perform decision-making processing according to the feedback information.

In an embodiment, the second node is a verification node, and the decision-making request is a request of a voting channel type, and the receiving, by a second node of a plurality of nodes, a decision-making request that is broadcasted by a first node of the plurality of nodes to at least two second nodes of the plurality of nodes includes receiving, by the second node, the decision-making request and verification information that are broadcasted by the first node to the plurality of second nodes; the method further includes: verifying, by the second node, according to the verification information, whether the second node has a corresponding authority to receive and process the request of the voting channel type; and verifying, by the second node, whether the decision-making request that is received corresponds to the voting channel type.

In an embodiment, the receiving, by the second node, feedback information for the decision-making request inputted by a user corresponding to the second node includes: receiving, by the second node, a request of a query type sent by the user corresponding to the second node when the user views all the requests of the voting channel type through the second node; extracting, by the second node, all the requests of the voting channel type from a database so that the user corresponding to the second node views all the requests of the voting channel type; and receiving, by the second node, a Remote Procedure Call Protocol (RPC) request of a vote_sign type with a specified voting request ID inputted by the user corresponding to the second node; and the Remote Procedure Call Protocol (RPC) request is configured to decide whether to approve an operation behavior included in the decision-making request.

In an embodiment, the broadcasting, by the second node, the feedback information to at least two third nodes of the plurality of nodes except the second node includes: filling in, by the second node, a sender field in the decision-making request with a public key of the second node; filling, by the second node, an ID field of the feedback information with a unique request ID of the decision-making request, and signing the feedback information; and broadcasting, by the second node, signed feedback information to the at least two third nodes.

In an embodiment, the performing decision-making processing by the at least two third nodes according to the feedback information includes: processing, by each of the at least two third nodes, the decision-making received from other nodes; calculating a decision-making weight and adding the decision-making weight to the decision-making received from other nodes; determining, by the at least two third nodes, whether an execution condition is satisfied after receiving a request for an execution operation, and performing the execution operation after the execution condition is verified to be satisfied, and the execution operation of a corresponding voting result is initiated by the first node that initiates the decision-making request when the decision-making weight satisfies a preset condition; and displaying, by the at least two third nodes, a decision-making result after completing the decision-making.

According to another aspect of the embodiments of the present application, a method for supporting artificial participation in decision-making of blockchain is provided, which includes: broadcasting, by a first node of a plurality of nodes in the blockchain, a decision-making request to at least two second nodes of the plurality of nodes so that each second node of the at least two second nodes broadcasts feedback information to at least two third nodes of the plurality of nodes after receiving the feedback information for the decision-making request inputted by a user corresponding to each second node of the at least two second nodes, so that the at least two third nodes perform decision-making processing according to the feedback information; and performing, by the first node, the decision-making processing according to the feedback information inputted by the user, and initiating an execution operation of a voting result to the at least two third nodes.

In an embodiment, the broadcasting, by a first node of a plurality of nodes, a decision-making request to at least two second nodes of the plurality of nodes includes: broadcasting, by the first node, the decision-making request and verification information to the at least two second nodes, and the verification information is configured to verify an authority of the second node.

In an embodiment, the broadcasting, by the first node, the decision-making request and verification information to the at least two second nodes includes: acquiring, by the first node, a type of the decision-making request selected by the user, and selecting a channel function according to the type of the decision-making request; and broadcasting, by the first node, the decision-making request and the verification information to the at least two second nodes through the channel function, and the decision-making request includes a Remote Procedure Call Protocol (RPC) request.

In an embodiment, the performing decision-making processing by at least two third nodes according to the feedback information includes: processing, by each of the at least two third nodes, the decision-making received from other nodes, and calculating a decision-making weight and adding the decision-making weight to the decision-making received from other nodes; determining, by the at least two third nodes, whether an execution condition is satisfied after receiving a request for an execution operation, and performing the execution operation after the execution condition is verified to be satisfied, wherein the execution operation of a corresponding voting result is initiated by the first node that initiates the decision-making request when the decision-making weight satisfies a preset condition; and displaying, by the at least two third nodes, a decision-making result after completing the decision-making.

According to another aspect of the embodiments of the present application, an electronic device is provided, which includes: a decision-making receiving module, configured to receive a decision-making request that is broadcasted by a first node of a plurality of nodes to at least two second nodes of the plurality of nodes; an input receiving module, configured to receive feedback information for the decision-making request inputted by a user corresponding to the second node; and a broadcasting module, configured to broadcast the feedback information to at least two third nodes of the plurality of nodes except the second node so that the at least two third nodes perform decision-making processing according to the feedback information.

According to a third aspect of the embodiments of the present application, a computer readable storage medium is provided, which stores a computer program that, when executed by a processor, cause the processor to perform the above mentioned method for supporting artificial participation in decision-making of blockchain.

A method and an electronic device for supporting artificial participation in decision-making of blockchain of the embodiments of the present application, enable a user to initiate and participate in voting through receiving, at a node of blockchain, feedback information inputted by the user and broadcasting the feedback information to other nodes for performing the decision-making processing, avoiding restrictions on decision-making initiation and participation, meanwhile avoiding dependence on the network and improving stability. In addition, security of a decision-making process is improved by verifying the verification information.

### BRIEF DESCRIPTION OF DRAWINGS

In order to more clearly illustrate the technical solutions of the embodiments of the present application, the accompanying drawings to be used in the description of the embodiments will be briefly described below. It is obvious that the accompanying drawings in the following description are only some embodiments of the present application. Without any creative efforts, other accompanying drawings may also be obtained based on the accompanying drawings for those of ordinary skill in the art.

FIG. 1 is a schematic structural diagram of a method for supporting artificial participation in decision-making of blockchain according to embodiments of the present application.

FIG. 2 is a flowchart of a method for supporting artificial participation in decision-making of blockchain according to embodiments of the present application.

FIG. 3 is a flowchart of a method for supporting artificial participation in decision-making of blockchain according to embodiments of the present application.

FIG. 4 is a schematic structural diagram of an electronic device according to embodiments of the present application.

FIG. 5 is a flowchart of a method for supporting artificial participation in decision-making of blockchain according to an exemplary embodiment of the present application.

### DETAILED DESCRIPTION

To make objectives, technical solutions and advantages of embodiments of the present invention clearer, the technical solutions in the embodiments of the present application are clearly and completely described in the following with reference to the accompanying drawings in the embodiments of the present application. It is apparent that the described embodiments are only a part of the embodiments of the present application, but not all of the embodiments. All other embodiments obtained by a person of ordinary skill in the art based on the embodiments of the present application without creative efforts are within the scope of the present application.

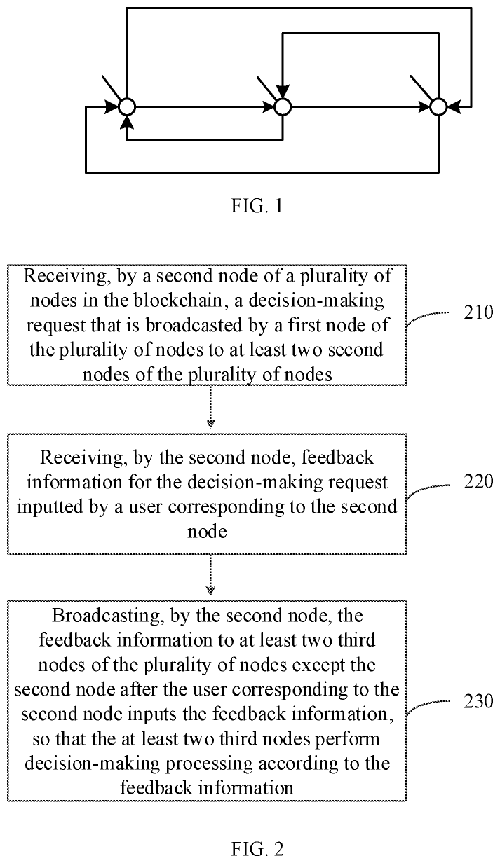

In order to make the description clearer, FIG. 1 is a schematic structural diagram of a method for supporting artificial participation in decision-making of blockchain according to embodiments of the present application.

In FIG. 1, nodes in the blockchain are simply divided according to functions, and the nodes mainly include a first node 110, a second node 120, and a third node 130. The first node 110 is a node that initiates a decision-making, and the node that initiates the decision-making may be any node in the blockchain. The first node 110 may initiate a decision-making request to any node, as in FIG. 1, to the second node 120; the second node 120 is a node that receives the decision-making request broadcasted by the first node 110, and the second node 120 may be any node having an authority except the first node 110. And the second nodes 120 may also send and receive information to each other (not shown in the FIG). In addition to receiving the decision-making request broadcasted by the first node 110, the second node 120 may also receive feedback information (not shown in the FIG) for the decision-making request inputted by a corresponding user. And after the corresponding user inputs the feedback information, the second node 120 may broadcast the feedback information to any other nodes, which may be either the first node 110 or the third node 130 in this FIG. The number of the third node 130 is not limited, and the third nodes 130 may also send and receive the information from each other (not shown in the FIG). The third node 130 is mainly configured to make statistics on all received feedback information from the second node 120 and perform decision-making processing. As shown in the FIG, the first node 110 and the third node 130 may also send and receive the information from each other. And therefore, if the decision-making which is processed satisfies a preset condition, the first node 110 will initiate an execution operation of a corresponding voting result to other nodes, which may be either the second node 120 or the third node 130, i.e., make a record on the blockchain. All nodes except the first node 110, which may be the second node 120 or the third node 130, may display a decision-making result.

It should be understood that in the actual blockchain, the nodes are not divided according to FIG. 1, and all nodes may send and receive the information to each other. The division in FIG. 1 is only for illustrating the functions of each node. It is to be noted that the functions of the nodes and the number of the nodes of embodiments of the present application are not limited thereto.

FIG. 2 is a flowchart of a method for supporting artificial participation in decision-making of blockchain according to embodiments of the present application, the method includes the following contents.

S210: receiving, by a second node of a plurality of nodes in the blockchain, a decision-making request that is broadcasted by a first node of the plurality of nodes to at least two second nodes of the plurality of nodes.

A plurality of nodes may be included in the blockchain. The second node may be understood as an intermediate node, and is configured to receive the decision-making request initiated by the first node, perform a series of processing on the decision-making request, and then send a processed decision-making request to other nodes. The first node is an initiating node of the decision-making, and is responsible for initiating the decision-making request. A type of the decision-making request may be a voting decision-making request. For example, the first node initiates the voting decision-making request such as “to have Western food in the evening?” to the second node, the second node may process a series of voting decision-making requests for the “to have Western food in the evening” and then send to other nodes.

S220: receiving, by the second node, feedback information for the decision-making request inputted by a user corresponding to the second node.

Since artificial participation is involved, the user viewed through the second node may input the feedback information for the decision-making at the second node after viewing the decision-making request. For example, the user corresponding to the second node may first view through the second node all the voting requests at the second node, which may be other requests such as “to have Western food in the morning” or “to have Western food at noon”, etc. The user may choose to give feedback on the decision-making request of the “to have Western food in the evening” for voting, i.e., voting, wherein the feedback information in this example may be “to have” or “not to have”. A process of the user inputting the feedback at the second node on whether to have Western food may be a process of the second node receives the feedback information for a certain decision-making request inputted by the user corresponding to the second node.

S230: broadcasting, by the second node, the feedback information to at least two third nodes of the plurality of nodes except the second node after the user corresponding to the second node inputs the feedback information, so that the at least two third nodes perform decision-making processing according to the feedback information.

Specifically, after receiving the feedback information inputted by the user, the second node broadcasts the feedback information to other nodes. If the second node is a single node, then the broadcast to other nodes does not include the second node itself. Therefore, it is defined that an effect of the third node may be a node that performs the decision-making processing according to the feedback information, and the third node may include some of the second node, but does not include a sending node itself. In an actual application, after receiving the feedback information inputted by the user, a node may broadcast information including the feedback information to any node except the node itself, and the any node may further process the decision-making according to the feedback information.

In embodiments of the present application, the second node has a function that allows the user corresponding to the second node to input the feedback information, which enables the user to initiate and participate in voting through the node of the blockchain, avoids restrictions on decision-making initiation and participation, meanwhile avoids dependence on the network and improving stability due to the characteristics of the blockchain itself. In an embodiment, the second node is a verification node, and the decision-making request is a request of a voting channel type. And the receiving, by a second node of a plurality of nodes, a decision-making request that is broadcasted by a first node of the plurality of nodes to at least two second nodes of the plurality of nodes includes: the second node receives the decision-making request and verification information that are broadcasted by the first node to a plurality of second nodes. The method of FIG. 2 further includes: verifying, by the second node, according to the verification information, whether the second node has a corresponding authority to receive and process the request of the voting channel type; and verifying, by the second node, whether the decision-making request received corresponds to the voting channel type.

Specifically, the decision-making request sent by the first node to the second node may further include the verification information. The verification information may be a type of an encrypted channel function, for example, an encrypted voting channel function. The voting channel function is a carrier of the request. The encrypted voting channel function may first verify whether the received second node has the authority to vote by means of, for example, a public key or private key, or may verify through hash encryption whether the request of the voting channel has been tampered with, or whether the request of the voting channel is consistent with the decision-making request, etc. After the above verification is completed, the second node may start to let the corresponding user view the voting and input the feedback information.

The second node performs a verification first, when receiving the decision-making request sent by the first node, and thus may effectively improve security of a process of decision-making.

In an embodiment, the receiving, by the second node, feedback information for the decision-making request inputted by a user corresponding to the second node includes: receiving, by the second node, a request of a query type sent by the user corresponding to the second node when the user views through the second node all the requests of the voting channel type; extracting, by the second node, all the requests of the voting channel type from a database so that the user corresponding to the second node views all the requests of the voting channel type; and receiving, by the second node, a Remote Procedure Call Protocol (RPC) request of a vote_sign type with a specified voting request ID inputted by the user corresponding to the second node; and the Remote Procedure Call Protocol (RPC) request is configured to decide whether to approve an operation behavior included in the decision-making request.

If the user of the second node wants to vote, the request of the query type may be first sent. A query process is that the second node extracts all the requests of the voting channel type from the database so that the user may query which voting requests are to be voted, and then the user choose to vote on the voting request that the user wants to vote. The result of the voting is with a vote_sign of the ID of the voting request which is configured to identify the user who voted. The result of the voting is also attached with the Remote Procedure Call Protocol (RPC) request which is configured to decide whether to approve the operation behavior included in the decision-making request.

In embodiments of the present application, the second node includes a query function, which enables the user to view which voting requests are to be voted and increases a selection range of user voting, so that the applied range of the present application may be more extensive.

In an embodiment, the broadcasting, by the second node, the feedback information to at least two third nodes of the plurality of nodes except the second node includes: filling in, by the second node, a sender field in the decision-making request with a public key of the second node; filling, by the second node, an ID field of the feedback information with a unique request ID of the decision-making request, and signing the feedback information; and broadcasting, by the second node, signed feedback information to the at least two third nodes.

Before the second node broadcasts the feedback information of the user to the third node, the sender field in the decision-making request is also filled in with the public key of the second node, so that when the third node receives content broadcasted by the second node, the third node will use the public key to decrypt the feedback information, which increases protection of the feedback information and improves security. The second node may also fill the ID field of the feedback information with the unique request ID of the decision-making request, of which the purpose is to indicate which request of the voting channel type is for the signature request and to avoid confusion with other simultaneously existing requests of the voting channel type. The second node also signs the feedback information in order to further increase security of the process of decision-making.

In this embodiment, the sender field in the decision-making request is filled in as the public key of the node, and the feedback information is signed, thereby further improving security of the process of decision-making.

In an embodiment, at least two third nodes perform decision-making processing according to feedback information, including: processing, by each of the at least two third nodes, the decision-making received from other nodes; calculating a decision-making weight and adding the decision-making weight to the decision-making received from other nodes; determining, by the at least two third nodes, whether an execution condition is satisfied after receiving a request for an execution operation, and performing the execution operation after the execution condition is verified to be satisfied, wherein the execution operation of a corresponding voting result is initiated by the first node that initiates the decision-making request when the decision-making weight satisfies a preset condition; and displaying, by the at least two third nodes, a decision-making result after completing the decision-making.

The third node may receive the feedback information from the second node, and then calculate and add the decision-making weight. The decision-making weight may be adjusted according to persons skilled in the art, which is not limited by the embodiments of the present application. If the decision-making weight satisfies the preset condition, the first node may initiate the execution operation of a corresponding voting. For example, the preset condition may be that all nodes may accumulate a weighted weight value after receiving the request (signed voting information), and when an accumulated value exceeds ⅔, the first node initiates the execution operation of the corresponding voting, and records the entire voting on the blockchain. At this time, after receiving the execution operation request of making a record on the blockchain, the third node determines whether the third node satisfies the preset condition, and if the third node satisfies the preset condition, the third node performs the execution operation, i.e., a record is made on the blockchain, and then the third node displays the decision-making result.

The third node of this embodiment is mainly responsible for adding up the decision-making result and performing a corresponding operation, and a purposes of decentralization is realized by a separation of the function of the nodes, so that the whole process of the decision-making does not depend on the traditional centralized server, and security is increased.

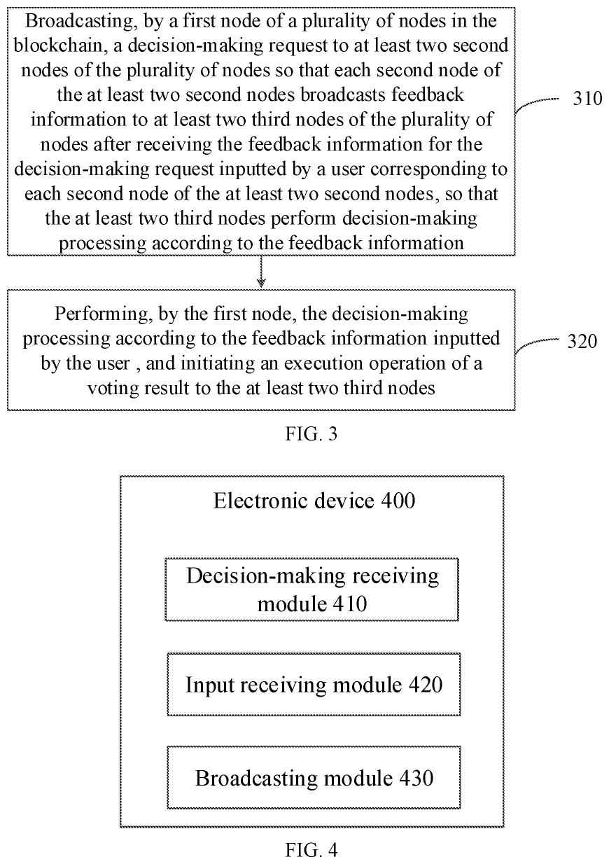

FIG. 3 is a flowchart of a method for supporting artificial participation in decision-making of blockchain according to embodiments of the present application, which includes the following contents:

S310: broadcasting, by a first node of a plurality of nodes in the blockchain, a decision-making request to at least two second nodes of the plurality of nodes so that each second node of the at least two second nodes broadcasts feedback information to at least two third nodes of the plurality of nodes after a user corresponding to each second node of the at least two second nodes inputs the feedback information for the decision-making request, so that the at least two third nodes perform decision-making processing according to the feedback information.

A description herein is a description made from aspect of the first node. The first node, as an initiating node of the decision-making request, may broadcast the decision-making request to the second node, and then after the second node performs a series of operations, the decision-making request is sent to the third node. Then the third node would perform a series of operations, and when the preset condition is satisfied, the first node performs a corresponding operation, of which the details will not be described herein again.

S320: performing, by the first node, the decision-making processing according to the feedback information inputted by the user corresponding to the second node, and initiating an execution operation of a voting result to the at least two second nodes or third nodes.

As mentioned above, the first node may determine whether to or not to carry out the execution operation, i.e., whether to or not to record on the blockchain, according to the feedback information inputted by the user at the second node and the result added up by the third node, of which the details will not be described herein again.

It should be understood that, in embodiments of the present application, the first node is only one of the plurality of nodes in the blockchain, and is a node with special functions. The first node in this embodiment is responsible for initiating the decision-making request and performing or not performing the execution operation when the preset condition is satisfied, thereby realizing that the user initiates and participates in voting through the node in the blockchain, avoiding restrictions on decision-making initiation and participation, and distinguishing the functions of the nodes, and also avoiding dependence on the network and improving stability.

In an embodiment, the broadcasting, by a first node of a plurality of nodes, a decision-making request to at least two second nodes of the plurality of nodes includes: broadcasting, by the first node, the decision-making request and verification information to the at least two second nodes; and the verification information is configured to verify an authority of the second node.

Specifically, when the first node broadcasts the decision-making request to the second node, the content broadcasted includes the decision-making request and the verification information. The decision-making request is applied to the verification information. The verification information may be a type of an encrypted channel function, for example, an encrypted voting channel function. The voting channel function is a carrier of the request. The encrypted voting channel function may first verify whether the received second node has the authority to vote by means of, for example, a public key or private key, or may verify through Hash encryption whether the request of the voting channel has been tampered with, or whether the request of the voting channel is consistent with the decision-making request, etc.

The included verification information may enable the second node to first perform the verification when receiving the decision-making request sent by the first node, which may effectively improve security of a process of decision-making.

In an embodiment, the broadcasting, by the first node, the decision-making request and verification information to the at least two second nodes includes: acquiring, by the first node, a type of the decision-making request selected by the user, and selecting a channel function according to the type of the decision-making request; and broadcasting, by the first node, the decision-making request and the verification information to the at least two second nodes through the channel function; and the decision-making request includes a Remote Procedure Call Protocol (RPC) request.

Before the first node broadcasts the decision-making request, the user may first select the type of the decision-making request through the first node, and select the channel function according to the type of the decision-making request based on the type of the decision-making request, for example, select the decision-making request of “to have Western food in the evening”, and select the voting channel function corresponding thereto. The first node then broadcasts the decision-making request and the verification information to the at least two second nodes, and the decision-making request includes a Remote Procedure Call Protocol (RPC) request configured to decide whether to approve an operation behavior included in the decision-making request.

In an embodiment, the performing decision-making processing by at least two third nodes according to the feedback information includes: processing, by each of the at least two third nodes, the decision-making received from other nodes, and calculating a decision-making weight and adding the decision-making weight to the decision-making received from other nodes; determining, by the at least two third nodes, whether an execution condition is satisfied after receiving a request for an execution operation, and performing the execution operation after the execution condition is verified to be satisfied, wherein the execution operation of a corresponding voting result is initiated by the first node that initiates the decision-making request when the decision-making weight satisfies a preset condition; and displaying, by the at least two third nodes, a decision-making result after completing the decision-making.

The third node may receive the feedback information from the second node, and then calculate and add the decision-making weight. The decision-making weight may be adjusted according to persons skilled in the art, which is not limited by the embodiments of the present application. If the decision-making weight satisfies the preset condition, the first node may initiate the execution operation of a corresponding voting. For example, the preset condition may be that all nodes may accumulate a weighted weight value after receiving the request, and when an accumulated value exceeds ⅔, the first node initiates the execution operation of the corresponding voting, and records the entire voting on the blockchain. At this time, after receiving the execution operation request of making a record on the blockchain, the third node determines whether the third node satisfies the preset condition, and if the third node satisfies the preset condition, the third node performs the execution operation, i.e., a record is made on the blockchain, and then the third node displays the decision-making result.

In this embodiment, the third node is mainly responsible for adding up the decision-making result and performing a corresponding operation, and a purposes of decentralization is realized by a separation of the function of the nodes, so that the whole process of the decision-making does not depend on the traditional centralized server, and security is increased.

FIG. 4 is a schematic structural diagram of an electronic device according to embodiments of the present application. Modules in the schematic structural diagram are configured to perform the foregoing steps, of which the details will not be described herein again. The electronic device 400 includes a decision-making receiving module 410, an input receiving module 420 and a broadcasting module 430.

The decision-making receiving module 410 is configured to receive a decision-making request that is broadcasted by a first node of a plurality of nodes to at least two second nodes of the plurality of nodes.

The input receiving module 420 is configured to receive feedback information for the decision-making request inputted by a user corresponding to the second node.

The broadcasting module 430 is configured to broadcast the feedback information to at least two third nodes of the plurality of nodes except the second node so that the at least two third nodes perform decision-making processing according to the feedback information.

It should be noted that, when executing the method for supporting artificial participation in decision-making of blockchain, the system and the electronic device for supporting artificial participation in decision-making of blockchain according to the above-mentioned embodiments is only illustrated by the division of the above-mentioned functional modules as an example. In practical application, the above functions may be allocated to different functional modules according to the needs, i.e., the internal structure of the device is divided into different functional modules to complete all or part of the functions described above. In addition, the method, the system, and the electronic device for supporting artificial participation in decision-making of blockchain provided by the above embodiments are belonging to the same concept, and the specific implementation process is described in the method embodiments, of which the details will not be described herein again.

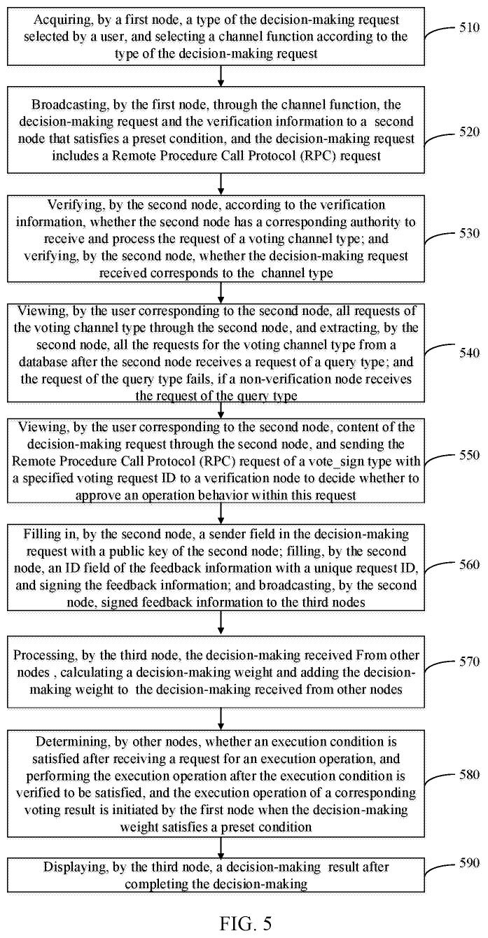

FIG. 5 is a flowchart of a method for supporting artificial participation in decision-making of blockchain according to an exemplary embodiment of the present application. The method for supporting artificial participation in decision-making of blockchain includes the following contents.

S510: acquiring, by a first node, a type of a decision-making request selected by a user, and selecting a channel function according to the type of the decision-making request.

The first node acquires the decision-making request of “to have Western food in the evening” selected by the user, and selects a voting channel function according to the type of the decision-making request.

S520: broadcasting, by the first node, through the channel function, the decision-making request and the verification information to a second node that satisfies a preset condition, and the decision-making request includes a Remote Procedure Call Protocol (RPC) request.

The first node broadcasts the decision-making request of “to have Western food in the evening” and the verification information to the second node, and the decision-making request of “to have Western food in the evening” includes the Remote Procedure Call Protocol (RPC) request configured to decide whether to approve an operation behavior included in the decision-making request. The verification information includes whether a type of an actual request included in the voting channel request is supported, whether signature information for sending the voting channel request is correct, and the like.

S530: verifying, by the second node, according to the verification information, whether the second node has a corresponding authority to receive and process the request of a voting channel type; and verifying, by the second node, whether the decision-making request received corresponds to the channel type.

After receiving content broadcasted by the first node, the second node verifies whether the second node has the authority to process and vote for the decision-making request of “to have Western food in the evening” according to the verification information. If the second node does not have the authority, the voting cannot be performed. Then the second node verifies whether the decision-making request of “to have Western food in the evening” is of the voting channel type. If the decision-making request of “to have Western food in the evening” does not correspond to the voting channel type, subsequent operations would not be executed.

S540: viewing, by the user corresponding to the second node, all requests of the voting channel type through the second node, and extracting, by the second node, all the requests of the voting channel type from a database after the second node receives a request of a query type; and the request of the query type fails, if a non-verification node receives the request of the query type.

Only the second node of the authority that has been verified in the previous step may receive a user's viewing request, and the viewing request fails, if other non-verification nodes receive the request of a query type. The viewing request is configured to view all the requests of the voting channel type and view the requests to be voted. For example, there may also be a voting of “to have Western food in the morning” or “to have Western food at noon”, which are stored in the database. When the second node receives the query request sent by the user, the second node takes the voting out to the user.

S550: viewing, by the user corresponding to the second node, content of the decision-making request through the second node, and sending the Remote Procedure Call Protocol (RPC) request of a vote_sign type with a specified voting request ID to a verification node to decide whether to approve an operation behavior within this request.

After the user corresponding to the second node views the content of the decision-making request of “to have Western food in the evening” through the second node, corresponding content is voted, for example, “not to have Western food”, and “not to have Western food” carries the Remote Procedure Call Protocol (RPC) request for the vote_sign type with the specified voting request ID. The vote_sign with the voting request ID is configured to identify the user who voted. A voting result is also accompanied by the Remote Procedure Call Protocol (RPC) request which is configured to decide whether to approve the operation behavior included in the decision-making request.

S560: filling in, by the second node, a sender field in the decision-making request with a public key of the second node; filling, by the second node, an ID field of the feedback information with a unique request ID, and signing the feedback information; and broadcasting, by the second node, signed feedback information to the third nodes.

This step is carried out before the second node sends the feedback information inputted by the user to the third node. The second node fills in the sender field in the decision-making request with the public key of the second node before the decision-making request is sent to the third node, so that when receiving the content broadcasted by the second node, the third node uses the public key to decrypt the feedback information, which increases protection of the feedback information and improves security. Then the ID field of the feedback information is filled with the unique request ID, and the feedback information is signed, in order to indicate which request of the voting channel type is for the signature request, and to avoid confusion with other simultaneously existing requests of the voting channel type. The second node also signs the feedback information in order to further increase security of a process of decision-making. Finally, signed feedback information is broadcast to the third node.

S570: processing, by the third node, the decision-making received from other nodes, calculating a decision-making weight and adding the decision-making weight to the decision-making received from other nodes.

After the third node receives signed decision-making information from the second node, weighted values are accumulated, for example, a voting performed by “investors” may accumulate more weight values, while other voting performed by “ordinary participants” may accumulate less weight values.

S580: determining, by other nodes, whether an execution condition is satisfied after receiving a request for an execution operation, and performing the execution operation after the execution condition is verified to be satisfied, and the execution operation of a corresponding voting result is initiated by the first node when the decision-making weight satisfies a preset condition.

Each node that receives the signed decision-making information (we define it as the third node) would accumulate the weighted values. When an accumulated value is greater than the preset condition, for example, ⅔, the first node may initiate the execution operation of the voting of “to have Western food in the evening”, i.e., all the voting about “to have Western food in the evening” are recorded on the blockchain, and after receiving the execution operation of making a record on the blockchain, other node (which may include the second node and the third node) then determine whether itself satisfies the execution condition and make the record on the blockchain after the execution condition is verified to be satisfied.

S590: displaying, by the third node, a decision-making result after completing the decision-making.

After the decision-making of “to have Western food in the evening” is completed, the third node (the third node refers to a node that may display the decision-making result, herein may be all nodes including the first node and the second node) may display the voting of a specific voting request and execution results thereof.

A method for supporting artificial participation in decision-making of blockchain provided by the exemplary embodiment enables a user to initiate and participate in voting through a node, avoids restrictions on decision-making initiation and participation through decentralization, avoids dependence on the network, and improves stability. In addition, security is improved by verifying the verification information.

Persons skilled in the art may understand that all or part of the steps of implementing the above embodiments may be completed by hardware, or may be completed by related hardware executed by a program, and the program may be stored in a computer readable storage medium. The storage medium mentioned above may be a read only memory, a magnetic disk or an optical disk or the like.

The above are only the preferred embodiments of the present application, and are not intended to limit the scope of the present application. Any modifications, equivalents, improvements, etc. made within the spirit and principles of the present application should be included within the scope of the protection of the present application.

What is claimed is:

1. A method for supporting artificial participation in decision-making of blockchain, comprising:
receiving, by a second node of a plurality of nodes in the blockchain, a decision-making request that is broadcasted by a first node of the plurality of nodes to at least two second nodes of the plurality of nodes;
receiving, by the second node, feedback information for the decision-making request inputted by a user corresponding to the second node; and
broadcasting, by the second node, the feedback information to at least two third nodes of the plurality of nodes except the second node after the user corresponding to the second node inputs the feedback information, so that the at least two third nodes perform decision-making processing according to the feedback information.

2. The method of claim 1, wherein the second node is a verification node, and the decision-making request is a request of a voting channel type, and the receiving, by a second node of a plurality of nodes, a decision-making request that is broadcasted by a first node of the plurality of nodes to at least two second nodes of the plurality of nodes comprises: receiving, by the second node, the decision-making request and verification information that are broadcasted by the first node to the plurality of second nodes,
wherein the method further comprises:
verifying, by the second node, according to the verification information, whether the second node has a corresponding authority to receive and process the request of the voting channel type; and
verifying, by the second node, whether the decision-making request received corresponds to the voting channel type.

3. The method of claim 2, wherein the receiving, by the second node, feedback information for the decision-making request inputted by a user corresponding to the second node comprises:
receiving, by the second node, a request of a query type sent by the user corresponding to the second node when the user views all the requests of the voting channel type through the second node;
extracting, by the second node, all the requests of the voting channel type from a database, so that the user corresponding to the second node views all the requests of the voting channel type; and
receiving, by the second node, a Remote Procedure Call Protocol (RPC) request of a vote_sign type with a specified voting request ID inputted by the user corresponding to the second node, wherein the Remote Procedure Call Protocol (RPC) request is configured to decide whether to approve an operation behavior included in the decision-making request.

4. The method of claim 3, wherein the broadcasting, by the second node, the feedback information to at least two third nodes of the plurality of nodes except the second node comprises:
filling in, by the second node, a sender field in the decision-making request with a public key of the second node;
filling, by the second node, an ID field of the feedback information with a unique request ID of the decision-making request, and signing the feedback information; and
broadcasting, by the second node, signed feedback information to the at least two third nodes.

5. The method of claim 1, wherein the performing decision-making processing by the at least two third nodes according to the feedback information comprises:
processing, by each of the at least two third nodes, the decision-making received from other nodes, calculating a decision-making weight and adding the decision-making weight to the decision-making received from other nodes;
determining, by the at least two third nodes, whether an execution condition is satisfied after receiving a request for an execution operation, and performing the execution operation after the execution condition is verified to be satisfied, wherein the execution operation of a corresponding voting result is initiated by the first node that initiates the decision-making request when the decision-making weight satisfies a preset condition; and
displaying, by the at least two third nodes, a decision-making result after completing the decision-making.

6. A method for supporting artificial participation in decision-making of blockchain, comprising:
broadcasting, by a first node of a plurality of nodes in the blockchain, a decision-making request to at least two second nodes of the plurality of nodes so that each second node of the at least two second nodes broadcasts feedback information to at least two third nodes of the plurality of nodes after receiving the feedback information for the decision-making request inputted by a user corresponding to each second node of the at least second nodes, so that the at least two third nodes perform decision-making processing according to the feedback information; and
performing, by the first node, the decision-making processing according to the feedback information inputted by the user, and initiating an execution operation of a voting result to the at least two third nodes.

7. The method of claim 6, wherein the broadcasting, by a first node of a plurality of nodes, a decision-making request to at least two second nodes of the plurality of nodes comprises:
broadcasting, by the first node, the decision-making request and verification information to the at least two second nodes, wherein the verification information is configured to verify an authority of the second node.

8. The method of claim 7, wherein the broadcasting, by the first node, the decision-making request and verification information to the at least two second nodes comprises:
acquiring, by the first node, a type of the decision-making request selected by the user, and selecting a channel function according to the type of the decision-making request; and
broadcasting, by the first node, the decision-making request and the verification information to the at least two second nodes through the channel function, wherein the decision-making request comprises a Remote Procedure Call Protocol (RPC) request.

9. The method of claim 6, wherein the performing decision-making processing by at least two third nodes according to the feedback information comprises:
processing, by each of the at least two third nodes, the decision-making received from other nodes; calculating a decision-making weight and adding the decision-making weight to the decision-making received from other nodes;
determining, by the at least two third nodes, whether an execution condition is satisfied after receiving a request for an execution operation, and performing the execution operation after the execution condition is verified to be satisfied, wherein the execution operation of a corresponding voting result is initiated by the first node that initiates the decision-making request when the decision-making weight satisfies a preset condition; and
displaying, by the at least two third nodes, a decision-making result after completing the decision-making.

10. A computer readable storage medium storing a computer program that, when executed by a processor, causes the processor to:
receive a decision-making request that is broadcasted by a first node of a plurality of nodes to at least two second nodes of the plurality of nodes;
receive feedback information for the decision-making request inputted by a user corresponding to the second node; and
broadcast the feedback information to at least two third nodes of the plurality of nodes except the second node, so that the at least two third nodes perform decision-making processing according to the feedback information.

11. The computer readable storage medium according to claim 10, wherein the second node is a verification node, and the decision-making request is a request of a voting channel type, the processor is further configured to:
receive the decision-making request and verification information that are broadcasted by the first node to the plurality of second nodes;
verify, according to the verification information, whether the second node has a corresponding authority to receive and process the request of the voting channel type; and
verify whether the decision-making request received corresponds to the voting channel type.

12. The computer readable storage medium according to claim 11, the processor is configured to:
receive a request of a query type sent by the user corresponding to the second node when the user views all the requests of the voting channel type through the second node;
extract all the requests of the voting channel type from a database, so that the user corresponding to the second node views all the requests of the voting channel type; and
receive a Remote Procedure Call Protocol (RPC) request of a vote_sign type with a specified voting request ID inputted by the user corresponding to the second node, wherein the Remote Procedure Call Protocol (RPC) request is configured to decide whether to approve an operation behavior included in the decision-making request.

13. The computer readable storage medium according to claim 12, the processor is configured to:
fill in a sender field in the decision-making request with a public key of the second node;
fill an ID field of the feedback information with a unique request ID of the decision-making request, and signing the feedback information; and
broadcast signed feedback information to the at least two third nodes.

14. The computer readable storage medium according to claim 10, the processor is configured to:
process the decision-making received from other nodes, calculate a decision-making weight and add the decision-making weight to the decision-making received from other nodes;
determine whether an execution condition is satisfied after a request for an execution operation is received, and perform the execution operation after the execution condition is verified to be satisfied, wherein the execution operation of a corresponding voting result is initiated by the first node that initiates the decision-making request when the decision-making weight satisfies a preset condition; and
display a decision-making result after completing the decision-making.

15. A computer readable storage medium storing a computer program that, when executed by a processor, causes the processor to:
broadcast a decision-making request to at least two second nodes of a plurality of nodes in the blockchain so that each second node of the at least two second nodes broadcasts feedback information to at least two third nodes of the plurality of nodes after receiving the feedback information for the decision-making request inputted by a user corresponding to each second node of the at least second nodes, so that the at least two third nodes perform decision-making processing according to the feedback information; and
perform the decision-making processing according to the feedback information inputted by the user, and initiate an execution operation of a voting result to the at least two third nodes.

16. The computer readable storage medium according to claim 15, the processor is configured to:
broadcast the decision-making request and verification information to the at least two second nodes, wherein the verification information is configured to verify an authority of the second node.

17. The computer readable storage medium according to claim 16, the processor is configured to:
acquire a type of the decision-making request selected by the user, and select a channel function according to the type of the decision-making request; and
broadcast the decision-making request and the verification information to the at least two second nodes through the channel function, wherein the decision-making request comprises a Remote Procedure Call Protocol (RPC) request.

18. The computer readable storage medium according to claim 15, the processor is configured to:
process the decision-making received from other nodes, calculate a decision-making weight and add the decision-making weight to the decision-making received from other nodes;
determine whether an execution condition is satisfied after a request for an execution operation is received, and perform the execution operation after the execution condition is verified to be satisfied, wherein the execution operation of a corresponding voting result is initiated by the first node that initiates the decision-making request when the decision-making weight satisfies a preset condition; and
display a decision-making result after completing the decision-making.
